(19) United States
(12) Patent Application Publication
(10) Pub. No.: US 2010/0064353 A1
(43) Pub. Date: Mar. 11, 2010

(54) User Mapping Mechanisms

(75) Inventors: Dan Kan, San Jose, CA (US); Jae Kim, Dublin, CA (US); Vivek Vallachira, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FaceTime Communications, Inc., Belmont, CA (US)

(21) Appl. No.: 12/206,929

(22) Filed: Sep. 9, 2008

(51) Int. Cl. G06F 21/00; G06F 15/173

(52) U.S. Cl. 726/5; 709/223

(57) ABSTRACT

In various embodiments, techniques can be provided for identifying a user or group of users who initiated network traffic. The user or group of users may be identified as an employee who can be found in corporate or organizational directory. In some embodiments, different authentication mechanisms may be used for various types of network traffic. For example, by proxying instant messaging (IM) communications, a proxy server can know which users are associated with what network traffic. In another example, transparent and non-transparent mechanisms may be provided to authenticate HTTP URL traffic. For other types of traffic, such as non-proxied IM, P2P, and spyware, an existing authentication cache or credential cache may be used to identify the user who generated the traffic.

### BACKGROUND OF THE INVENTION

This application relates to the field of computer networks, and specifically to software and hardware for identifying users who initiate network traffic.

With the advent of modern computers and computer networks, users have been provided with a faster electronic means of communicating with each other. Browser applications, such as Internet Explorer from Microsoft Corporation and Firefox from the Mozilla Foundation, can allow users to browse the world-wide web, obtain news information, share photos or music, or the like, through computer networks, such as the Internet. In another example, e-mail and instant messaging can allow users to interact, for example, in real-time communications.

Computer networks can often include hundreds or thousands of network hosts. A network host can be a computer or other hardware device that runs software applications and originates and/or receives network flows. Network administrators may often be responsible for maintaining these network hosts in proper running order. The network administrators may incorporate a variety of methodologies and devices in an attempt to ensure the network operates securely and reliably. To that end, network administrators may often set rules or network policies for users, groups, and devices about the types of software applications and network traffic allowed on a network.

Network applications may include software applications on a network host that are responsible for originating and/or receiving network traffic flows, referred to as network flows. Some network applications may be well-behaved and conform with a network's rules and policies. Other network applications may be poorly-behaved, installing without a user's or network administrator's permission, hiding themselves and their operation, and violating a network's rules and policies. Examples of poorly-behaved network applications may include computer viruses, worms, spyware, and malware applications. Additionally, some more legitimate applications, such as instant messaging applications, file-sharing or other types of peer-to-peer network applications, voice-over IP (VOIP) communication applications, and multimedia applications may be responsible for network flows that can circumvent network policies and jeopardize network security and reliability.

Often, poorly-behaved network applications can attempt to conceal their network flows to avoid detection and disregard network policies. Common evasion techniques may include using non-standard network protocols, dynamic port and channel selection, which limits the effectiveness of monitoring and blocking network ports to control network traffic; HTTP/HTTPS tunneling, which hides network flows in normally-permitted web traffic; Peer-to-Peer onion routing, which selects destination addresses for peer-to-peer routing at random to circumvent destination address blocking; and encryption of network packet data, which prevents network monitors from examining the contents of network packets to identify the type of network flow.

For example, some common peer-to-peer VOIP applications can circumvent network policies in a number of ways. The peer-to-peer VOIP application may dynamically selected different ports and channels for communication. If UDP is blocked, the application can fall back on TCP/IP. Additionally, the peer-to-peer VOIP application may tunnel its data over open ports 80 or 443, which are normally intended for HTTP or SSL traffic. A peer-to-peer VOIP application may dynamically select sup emodes in its peer-to-peer network to circumvent destination address detection and blocking. Additionally, data may be encrypted to prevent detection using packet inspection.

Prior network monitoring applications generally monitor the content, size, and source and destination addresses of network flows as they pass through a gateway or other point in the network. However, prior network monitoring applications may have too little information to reliably identify users who initiate unauthorized network flows. Additionally due to the above evasion techniques, prior network monitoring applications may have too little information to reliably detect poorly-behaved network applications.

Accordingly, what is desired are improved methods and apparatus for solving some of the problems discussed above. Additionally, what is desired are improved methods and apparatus for reducing some of the drawbacks discussed above.

### BRIEF SUMMARY OF THE INVENTION

In various embodiments, techniques are provided for identifying a user or group of users who initiate network traffic. The user or group of users may be identified as an employee who can be found in corporate or organizational directory. In some embodiments, different authentication mechanisms may be used for various types of network traffic. For example, by proxying instant messaging (IM) communications, a proxy server can know which users are associated with what network traffic. In another example, transparent and non-transparent mechanisms may be provided to authenticate HTTP URL traffic. For other types of traffic, such as non-proxied IM, P2P, and spyware, an existing authentication cache or credential cache may be used to identify the user who generated the traffic.

Accordingly, various techniques may be used with different types of traffic (e.g., IM network traffic, HTTP network traffic, etc.) to transparently (i.e., without requiring user to supply username and password) map an unknown or unidentified network flow to a user. User mapping information may be obtained from one type of network traffic type, and applied to a completely different type of network traffic. For example, it may not be possible to identify users from P2P traffic flows because, in general, each P2P application may use very different protocols. In various embodiments, if a user has been previously authenticated and identified from one type of network traffic, such as HTTP via NTLM, cached or stored authentication information may be used to associate a previously unidentifiable P2P network traffic flow with the user. In another example, when a user's IM traffic is proxied, the proxy can authenticate and identify the user using IM's native authentication mechanisms. The proxy may store an IP address-to-User mapping to be used later for identifying other types of network traffic.

A further understanding of the nature, advantages, and improvements offered by those inventions disclosed herein may be realized by reference to remaining portions of this disclosure and any accompanying drawings.

### BRIEF DESCRIPTION OF THE DRAWINGS

In order to better describe and illustrate embodiments and/or examples of any inventions presented within this disclosure, reference may be made to one or more accompanying drawings. The additional details or examples used to describe the accompanying drawings should not be considered as limitations to the scope of any of the disclosed inventions, any of the presently described embodiments and/or examples, or the presently understood best mode of any invention presented within this disclosure.

FIG. 1 is a block diagram of a system for identifying users who initiate network traffic in one embodiment according to the present invention;

FIG. 2 is a block diagram of an embodiment of a network traffic manager in one embodiment according to the present invention;

FIG. 3 is a simplified flowchart of a method for policy-based management of network traffic in one embodiment according to the present invention;

FIGS. 4A, 4B, and 4C are a flowchart of a method for authenticating instant messaging traffic in one embodiment according to the present invention;

FIGS. 5A, 5B, 5C, 5D, and 5E are a flowchart of a method for authenticating HTTP URL traffic in one embodiment according to the present invention;

FIG. 6 is a block diagram of a system for agent-based managing of network traffic in one embodiment according to the present invention;

FIG. 7 is a flowchart of a method for querying machines to obtain user information for user-based network traffic management in one embodiment according to the present invention; and

FIG. 8 is a simplified block diagram of a computer system that may incorporate embodiments of the present invention.

### DETAILED DESCRIPTION OF THE INVENTION

In various embodiments, techniques can be provided for identifying a user or group of users who initiated network traffic. The user or group of users may be identified as an employee who can be found in corporate or organizational directory. In some embodiments, different authentication mechanisms may be used for various types of network traffic. For example, by proxying instant messaging (IM) communications, a proxy server can know which users are associated with what network traffic. In another example, transparent and non-transparent mechanisms may be provided to authenticate HTTP URL traffic. For other types of traffic, such as non-proxied IM, P2P, and spyware, an existing authentication cache or credential cache may be used to identify the user who generated the traffic.

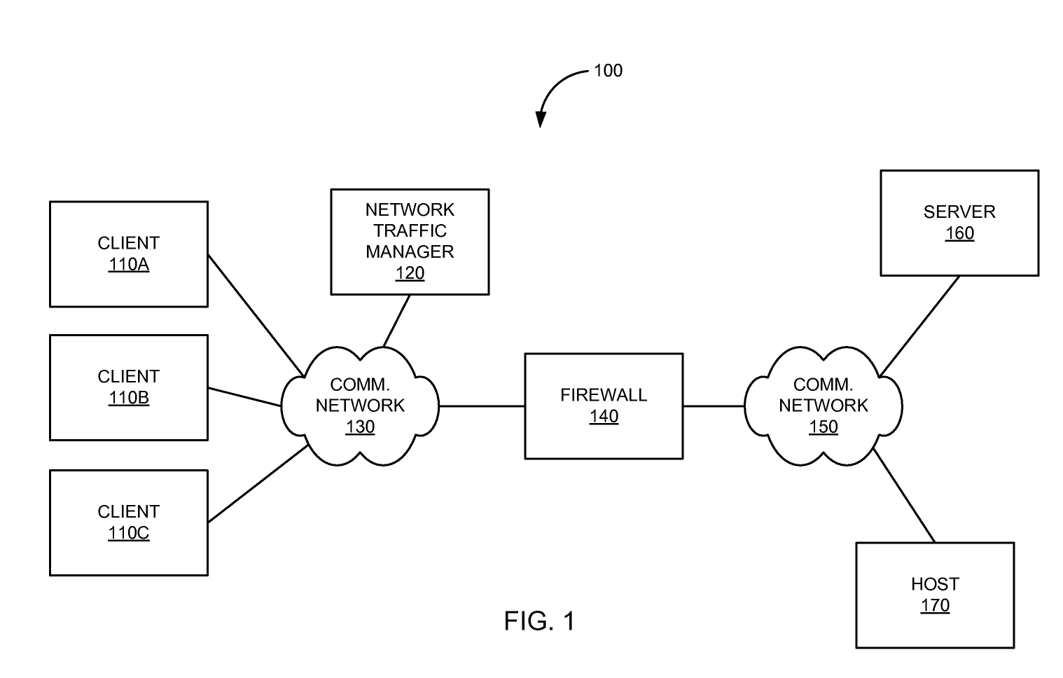

FIG. 1 is a block diagram of system 100 for identifying users who initiate network traffic in one embodiment according to the present invention. In this example, system 100 can include a plurality of clients 110 (e.g., client 110A, client 110B, and client 110C), network traffic manager 120, communications network 130, firewall 140, communications network 150, server 160, and host 170.

Clients 110 can include any computing device, such as a personal computer (PC), laptops, workstations, mainframes, pocket PC, personal digital assistant (PDA), RIM blackberry device, telephone, cellular phone, pager, etc. Clients 110 may include software applications on a network host that are responsible for originating and/or receiving network traffic. For example, client 110A may send instant message (IM) communications that include textual messages.

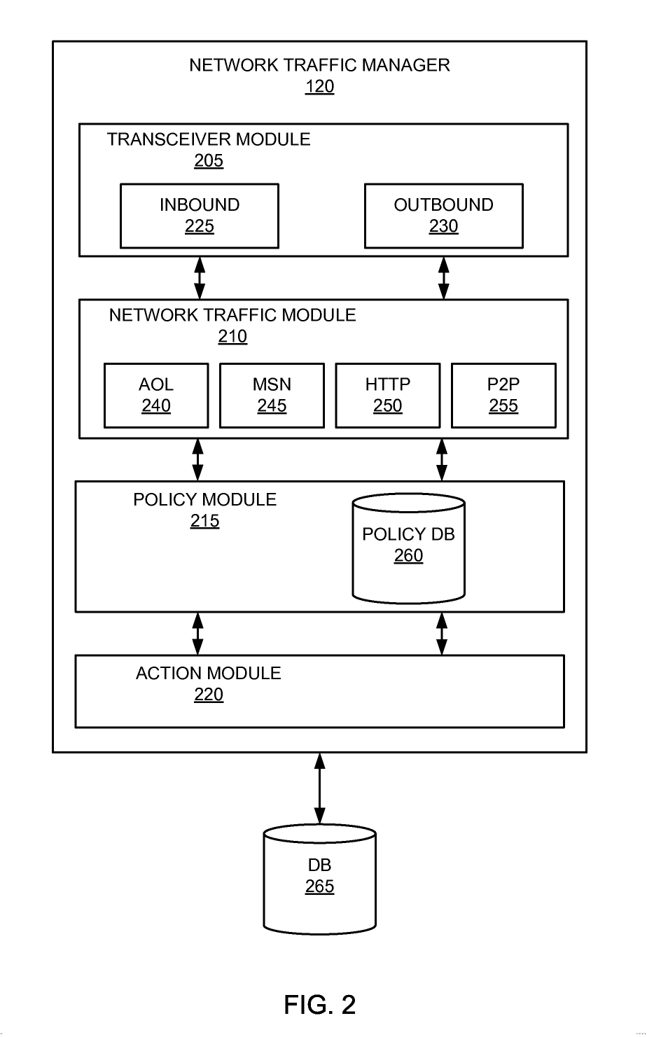

Network traffic manager 120 can include any hardware and/or software elements for user-based management of network traffic. Network traffic manager 120 may be embodied as a standalone device, appliance, or the like. In some embodiments, network manager 120 may form part of a computer system offering additional network services. One example of network traffic manager is discussed further with respect to FIG. 2.

Network traffic manager 120 may be implemented in a proxy server model, a server model, an event model, or any combination thereof. In the proxy server model, network traffic manager 120 may be situated in communications network 130 and acts as a proxy server between clients 110 and communications network 150. Network traffic manager 120 may support any kind of enterprise proxy protocols, such as SOCKS, HTTP, HTTPS.

In the proxy server model, network traffic manager 120 may intercept network traffic, or network flows. In one example, client 110A may connect to network traffic manager 120 by specifying host and port settings of network traffic manager 120 in the proxy settings of client 110A. Network traffic manager 120 then may connect to communications network 150 on behalf of clients 110A.

In the server model, network traffic manager 120 does not appear as a proxy for clients 110. Instead, clients 102 can connect to network traffic manager 120 in a client-to-server fashion. For example, client 110B may connect using a protocol that is specially defined for use between the client 110B and network traffic manager 120.

In the event model, network traffic manager 120 may interact with another network device, such as router or appliance that is deployed on communications network 130. The router or appliance may be responsible for sending events to network traffic manager 120. The events can include information indicating that something related to network traffic has taken place in router or appliance (e.g., an HTTP GET request, an IM client signed on/off; an IM client sent a text message to another IM client; the presence status of an IM client has changed; or the like). Once receiving the event, network traffic manager 120 may access the router or appliance through an interface (typically an application programmer's interface, or API for short). Network traffic manager 120 thus receives events encapsulating various details concerning network traffic flows.

Communications network 130 can include a public network, a private network, an enterprise local area network, an extranet, a wide area network, a metropolitan area network, or the like. In some embodiments, communications network 130 may form an enterprise network that defined by firewall 140. In these embodiments, any devices behind firewall 140 may be considered part of the enterprise network. Other devices outside of firewall 140 may be considered to be outside of the enterprise network. Accordingly, clients 110 and network traffic manager can be considered part of the enterprise network. Although firewall 140 is shown, it can be understood that firewall 140 may not be included in system 100.

Communications network 150 can include a public network, a private network, an enterprise local area network, an extranet, a wide area network, a metropolitan area network, or the like. Server 160 and host 170 can include hardware and/or software elements for responding to requests from clients 110. For example, server 160 or host 170 may include a web server, an application server, an FTP server, a VoIP server, a peer-to-peer (P2P) program, or the like.

In one example of operation for proxying IM traffic, network traffic monitor 120 may send an IM buddy name registration message to client 110A using an unmapped buddy name at the time of login. The IM buddy name registration message can contain a link that a user can follow to authenticate oneself. The user may have the option not to authenticate by just ignoring the IM buddy name registration message. In such a case, the user can be classified as an unknown or unmapped buddy name, and a default policy for unknown or unmapped buddy names can be applied, for example, block all unknown or unmapped buddy names. If the user enters valid credential (e.g., a valid username and password that can be authenticated), the user's buddy name can be mapped to the users credentials. Once the user's buddy name is mapped, the mapping may be cached for subsequent use and the IM buddy name registration message may not be displayed to the user any longer.

In another example of operation for authenticating HTTP URL traffic, network traffic monitor 120 can provide capabilities to authenticate or not authenticate all passby HTTP traffic. For example, upon receiving HTTP URL traffic from client 110B, network traffic monitor 120 may requests the user to authenticate. The authentication process may be transparent to the user using the user's web browser. In some embodiments, network traffic monitor 120 may redirect the user to a web page at which time the user may enter the user's credentials. Once a user is associated with corresponding HTTP URL traffic, the mapping may be cached for subsequent use.

In yet another example of operation, for other types of network traffic, such as unproxied or passby IM, P2P, spyware, malware, unauthorized application, or the like, network traffic monitor 120 may identify the users without explicit authentication by relying on previously cached credentials to resolve network traffic to a user.

FIG. 2 is a block diagram of an embodiment of network traffic manager 120 in one embodiment according to the present invention. Network traffic manager 120 can include transceiver module 205, network traffic module 210, policy module 215, and action module 220.

Transceiver module 205 can include hardware and/or software elements for receiving and transmitting network traffic. In one embodiment, transceiver module 205 may include inbound transceiver module 225 and outbound transceiver module 230. Inbound transceiver module 225 may handle network traffic received at network traffic manager 120, such as from clients 110 or server 160 of FIG. 1, and outbound transceiver module 230 may handle outbound network traffic generated network traffic manager 120, which may include network traffic generated on behalf of clients 110 or to server 160. For example, inbound transceiver module 225 may receive network traffic in the form of HTTP traffic, VoIP traffic, instant message communications, or the like from clients 110. Also, outbound transceiver module 230 may send TCP/IP traffic to clients 110, server 160, or host 170. In one embodiment, transceiver module 205 can receive network traffic through different models, such as a proxy model, a server model, and an event model. A person skilled in the art will appreciate other models that may be used to receive messages at network traffic manager 120.

In various embodiments, when transceiver module 205 receives network traffic, transceiver module 205 may send the network traffic to network traffic module 210. Network traffic module 210 can include hardware and/or software elements for operating on a network gateway, a server computer, or any other type of computer or other network hardware. Network traffic module 210 may be responsible for identifying the network traffic produced by an application, referred to as a network flow, and the identity of users, applications, and/or machines responsible for network flows.

In one embodiment, network traffic module 210 can receive data about network flows from different sources. For example, network traffic monitor 120 may monitor network traffic, or network flows, in system 100. Network traffic monitor 120 may utilize network traffic module 210 to collect information on network flows being sent or received by network applications within system 100, such as the source and destination addresses of network packets, the size of network data in network packets, the contents of network packets, the rate of related network packets in a network flow, and any other attributes of one or more network packets in a network flow.

Network traffic module 210 may use information obtained by network traffic monitor 120 to reliably identify network flows and associated network applications. In an embodiment, network traffic module 210 can employs a variety of techniques for identifying a user or group of users who initiated network traffic. The user or group of users may be identified as an employee who can be found in corporate or organizational directory. In some embodiments, different authentication mechanisms may for various types of network traffic. Authentication of network traffic then may occur based on whether one or more policies apply for the identified user or group.

In various embodiments, network traffic module 210 can interface with policy module 215. Policy module 215 can include hardware and/or software elements for enabling network administrators to set policies for network flows. A policy can include a set of rules, conditions, and actions. A policy may further be associated with one or more users, groups of users, devices, machines, or the like. Policies can be used to block, throttle, accelerate, enhance, or transform network traffic that is part of an identified network flow. In an embodiment, policies for network flows may be enforced by network traffic controlling devices such as switches, routers, firewalls, proxies, IPS, and EPS systems. Network traffic module 210 and policy module 215 can communicate with network traffic controlling devices via any interface or protocol, such as SNMP.

Policy module 215 may accesses a number of policies that include actions for network traffic. In one embodiment, policy module 215 may include policy database 260 that stores a set of policies. As shown, policy database 260 is located in policy module 215; however, it will be understood that policy database 260 may be located anywhere in network traffic manager 120 or be separate from network traffic manager 120.

The policies in policy database 260 may include actions that can be taken by network traffic monitor 120. The policies may be applied to a packet, group of packets, network flow, or the like. Policy module 215 may determine from user information, group information, machine information, characteristics related to network flows, or the like whether any policies in policy database 260 applies. Once a policy is determined by policy module 215, action module 220 may be configured to perform the action corresponding to the determined policy.

In various embodiments, database 265 may be used to store information usable for network traffic monitor 120. Database 265 may be included in network traffic monitor 120 or be separate from network traffic monitor 120. In one embodiment, database 265 can includes one or more information items including but not limited to: credential information, user information, user to IP address mappings, client identifications for clients 110, policies that may be implemented by policy module 215, or the like. This information is used by modules in network traffic manager 120 for any purpose.

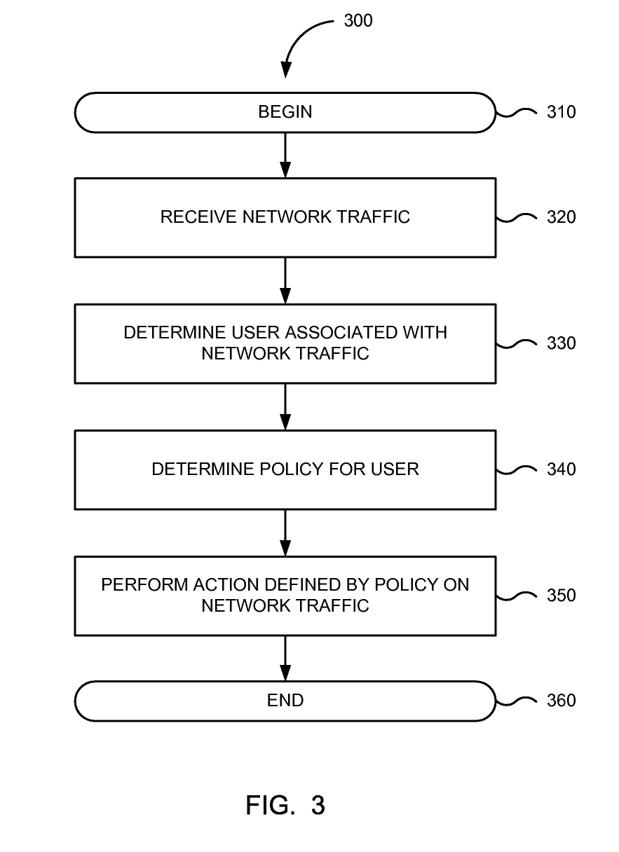

FIG. 3 is a simplified flowchart of method 300 for policy-based management of network traffic in one embodiment according to the present invention. The processing of method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. FIG. 3 begins in step 310.

In step 320, network traffic is received. For example, network traffic monitor 120 of FIG. 1 may monitor or otherwise obtain information about network traffic of communications network 130. In step 330, a user associated with the network traffic is determined. In various embodiments, this step may include identifying a network address (e.g., an IP address) of the source of the network traffic. A user-to-IP address mapping can provide, for example, information about a user who initiate the network traffic. Information about a user may be determined based on credentials supplied by a user or determined transparently.

In step 340, a policy is determined for the user. In step 350, an action defined by the determined policy is performed on the network traffic. Some examples of actions to be performed on network traffic may include actions to block, throttle, accelerate, enhance, or transform network traffic. FIG. 3 ends in step 360.

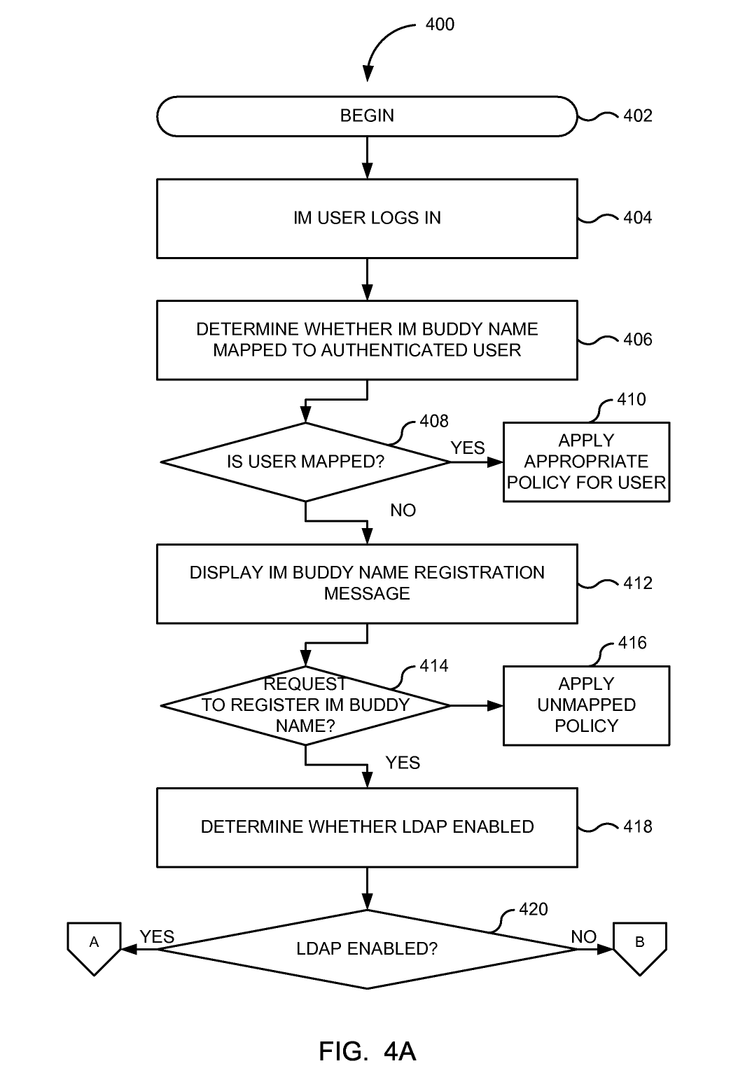

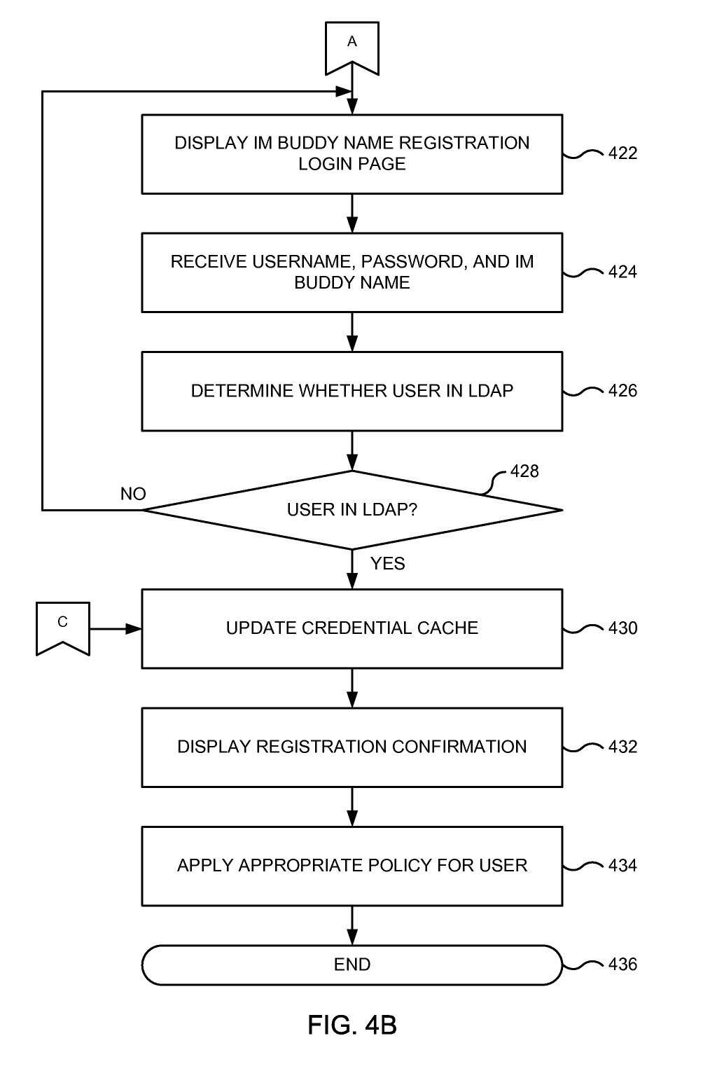

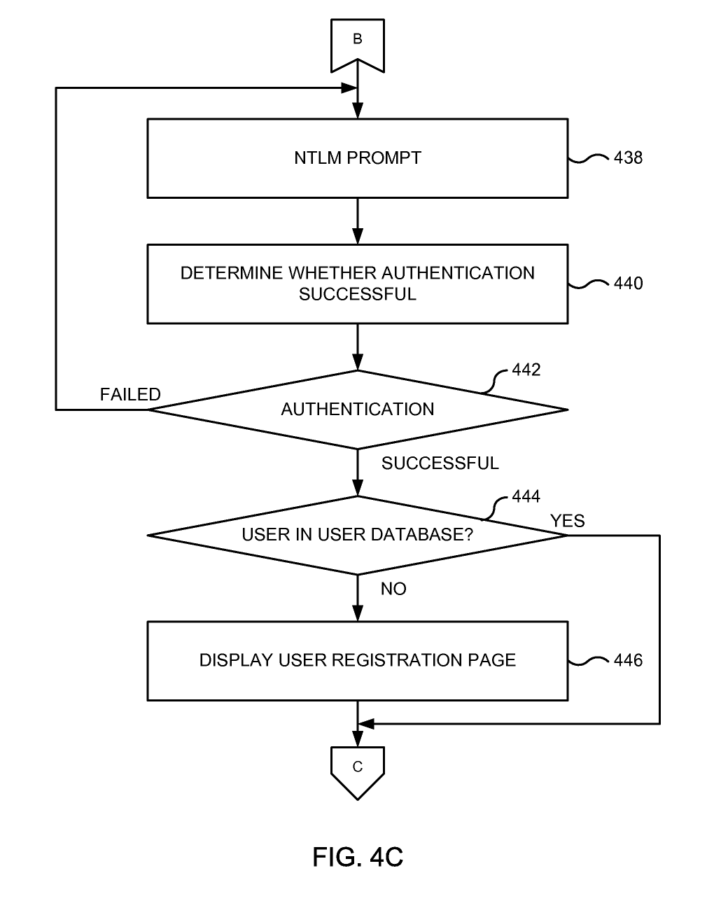

FIGS. 4A, 4B, and 4C are a flowchart of method 400 for authenticating instant messaging (IM) traffic in one embodiment according to the present invention. Method 400 relates generally to techniques for discouraging the anonymous use of an IM proxy and to ensure the policies established for IM network traffic can be applied. FIG. 4A begins in step 402.

In step 404, an IM user logs in to an IM proxy. For example, a user may point an IM client, such as AOL or MSN IM client to network traffic monitor 120 of FIG. 1 or another IM proxy server. The user may then supply the user's buddy name and password at the IM client which can be intercepted at or otherwise forwarded to network traffic manager 120. In step 406, a determination is made whether the user's IM buddy name is mapped to an authenticated user. In various embodiments, for example, network traffic monitor 120 may attempt to map any unmapped buddy names to existing users.

In step 408, if a determination is made that the user's IM buddy name is mapped to an authenticated user, in step 410, an appropriate policy is applied for the authenticated user. In step 408, if a determination is made that the user's IM buddy name is not mapped to an authenticated user, in step 412, an IM buddy name registration message is displayed to the user. In various embodiments, the IM buddy name registration message may be displayed using a webpage, a pop-up, an application dialog, or the like.

In step 414, a determination is made whether the user requested to register the user's IM buddy name. For example, in some embodiments, the IM buddy name registration message may include a URL link where user can authenticate oneself. A user may click on the URL link to register the user's IM buddy name. User can, however, ignore the IM buddy name registration message and continue to use proxy IM as an unmapped buddyname. In step 414, if a determination is made to not register the user's IM buddy name, an unmapped buddy name or unknown buddy name policy is applied for IM network traffic for the user.

In step 414, a determination is made to register the user's IM buddy name, the user may be taken to an authentication page. For example, once a user clicks on a register link in the IM buddy name registration message, a web browser can be launched and the user may be taken to the authentication page. The method of authentication can vary depending on the network infrastructure of an organization. For example, if LDAP settings are configured, a user may be authenticated by network traffic monitor 120 using an LDAP client. Alternatively, a user can be authenticated via NTLM against an Active Directory server.

For example, in step 420, a determination is made whether LDAP is enabled. In step 420, if a determination is made that LDAP is enabled, the processing of method 400 continues on FIG. 4B. In step 420, if a determination is made to LDAP is not enabled, the processing of method 400 continues on FIG. 4C.

Referring now to FIG. 4B, in step 422, and IM buddy name registration login page is displayed. In step 424, a username, password, and IM buddy name is received. In step 426, a determination is made whether the user is found in LDAP. For example, when a user enters a user ID and password, this credential pair may be checked against LDAP settings.

In step 428, if a determination is made that the user does not exist in LDAP, the user may not be allow to login to map the user's buddy name. If the user does not exist in LDAP, in step 428, for example, the user may be returned to the IM buddy name registration login page in step 422. In some embodiments, network traffic monitor 120 may not allow modification of user information in LDAP when the user is not found. In other embodiments, the user may be prompted for user information to be used to LDAP with the user information.

Alternatively, in step 428, if a determination is made that the user does exist in LDAP, a credential cache is updated in step 430. The credential cache may include user-to-IP address mappings. For example, information about authenticated users may be stored along with the IP addresses of computers or devices associated with the authenticated users. The credential cache may be used to subsequently authenticate network flows for a particular user.

In step 432, the user then may be directed to a registration confirmation. For example, the buddy name of the user may be shown as mapped to the user. In step 434, the appropriate policy is applied for the user. FIG. 4B ends in step 436.

Referring now to FIG. 4C, in various embodiments where LDAP settings are not configured but a domain controller may be, a user may be authenticated using a web browsers NTLM support. In step 438, an NTLM prompt may be displayed. In some instances, a user's browser can be configured to automatically provide credentials on the user's behalf in a transparent manner. In other instances, browsers may display a pop-up window to prompt for user IDs and passwords for NTLM credential. When a user's credentials are automatically supplied or when the user enters a user id and password in a dialog, the credential pair can be checked against domain controller. For example, in step 440, a determination is made whether authentication is successful to a domain controller.

In step 442, if authentication fails the NTLM prompt may be displayed again in step 438. Alternatively, in step 442, if authentication is successful, a determination may be made whether the user exists in an internal user database in step 444. In step 444, if a determination is made that the user exists in the user database, the processing of method 400 continues in step 430 of FIG. 4B.

If a determination is made that the user does not exist in the user database in step 444, a user registration page is displayed in step 446. For example, a user can be taken to an employee registration page where an employee ID is shown, and the user may be prompted for first/last name and email address. With the user provided first/last name and email address, an employee or user entity can be created in the user database. Once the employee or user is created, the user may be redirected to a registration confirmation page where the previously unmapped buddy name is shown as mapped to the newly created employee or user. For example, the processing of method 400 after step 446 continues in step 430 of FIG. 4B.

In various embodiments, a credential cache entry can be created at the time of buddy name mapping. Because a user may provide NTLM-authenticated or LDAP-authenticated user credential, these credentials may be used in creating a credential cache entry. When a mapped buddy name logs on from a specific IP address at later time, a credential cache entry can be updated to resolve IP address to the user to which the buddy name is mapped.

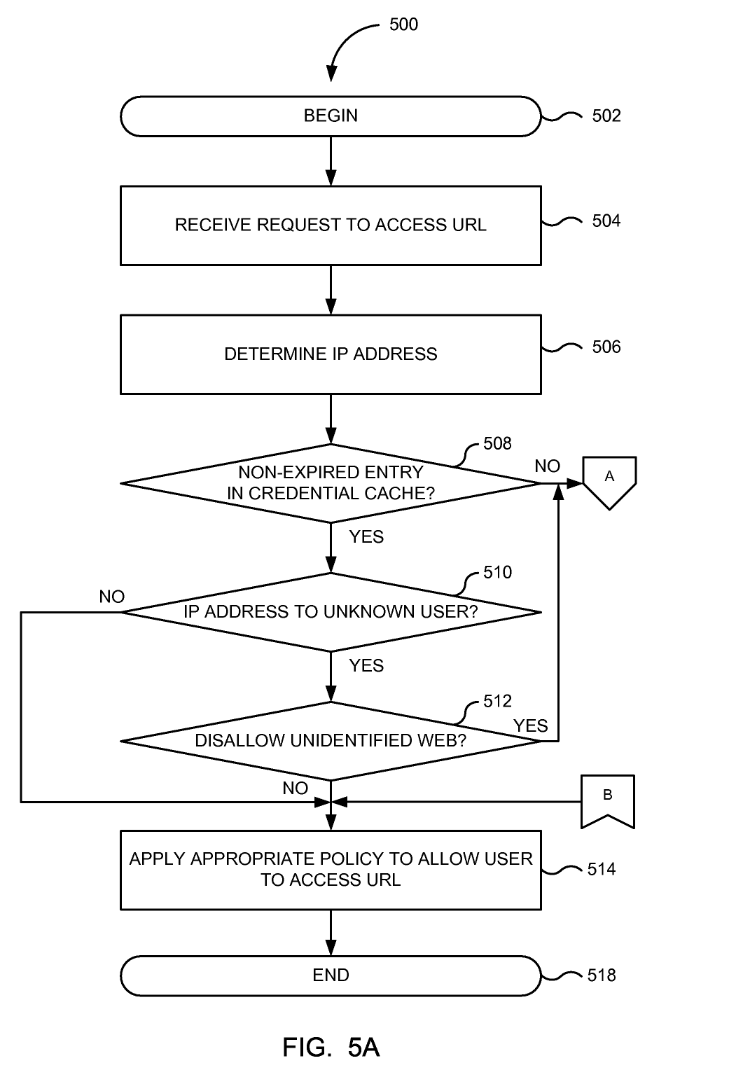

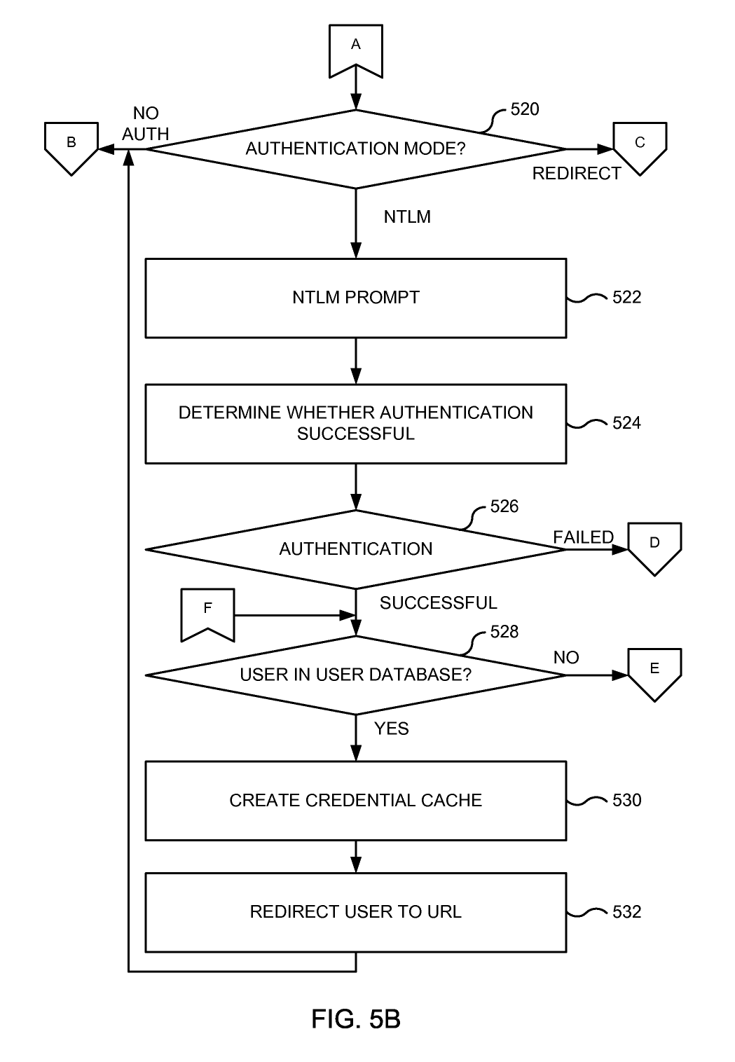

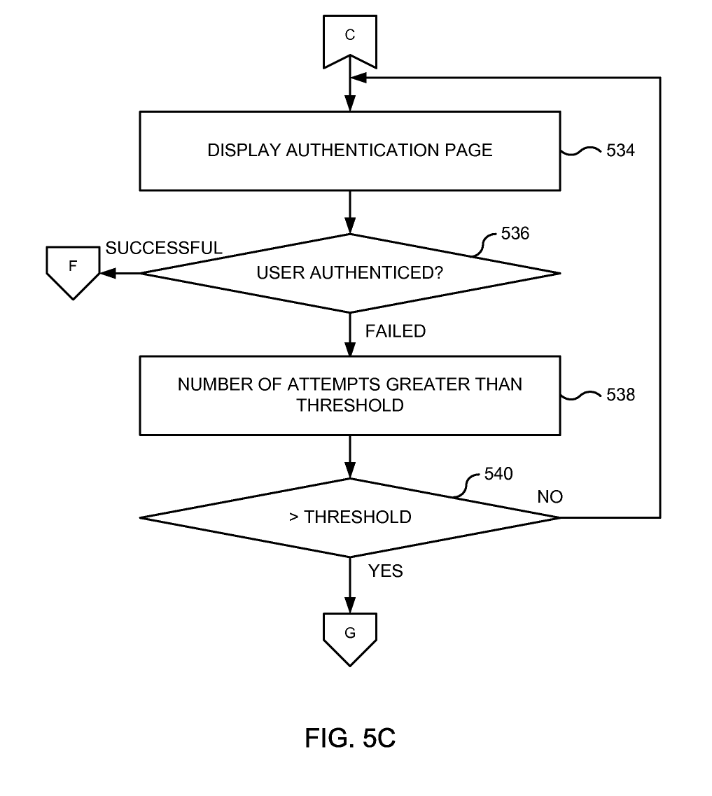

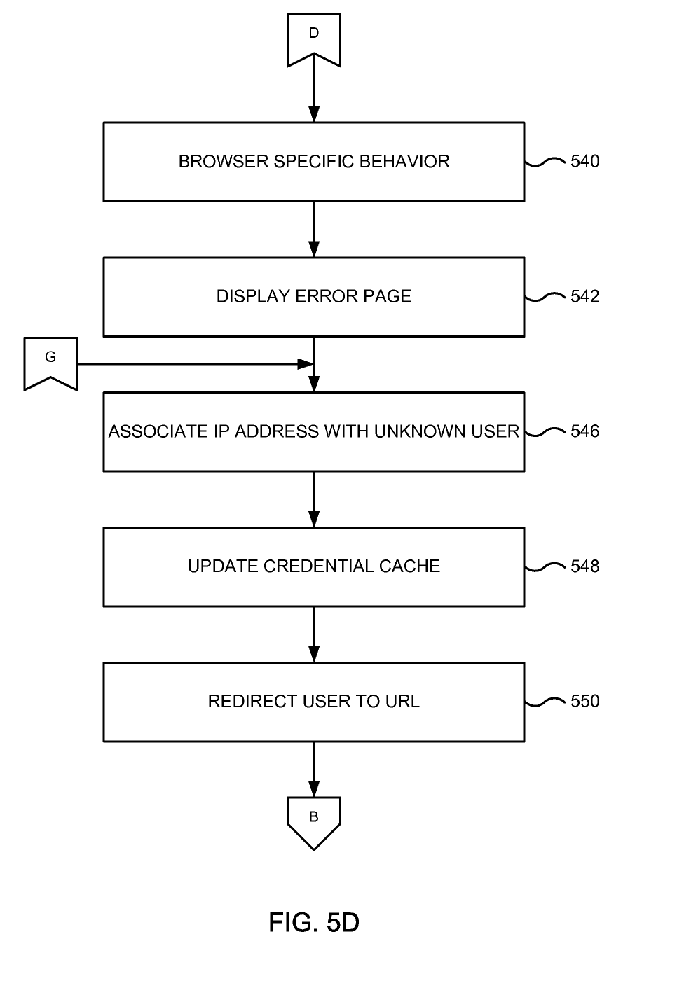

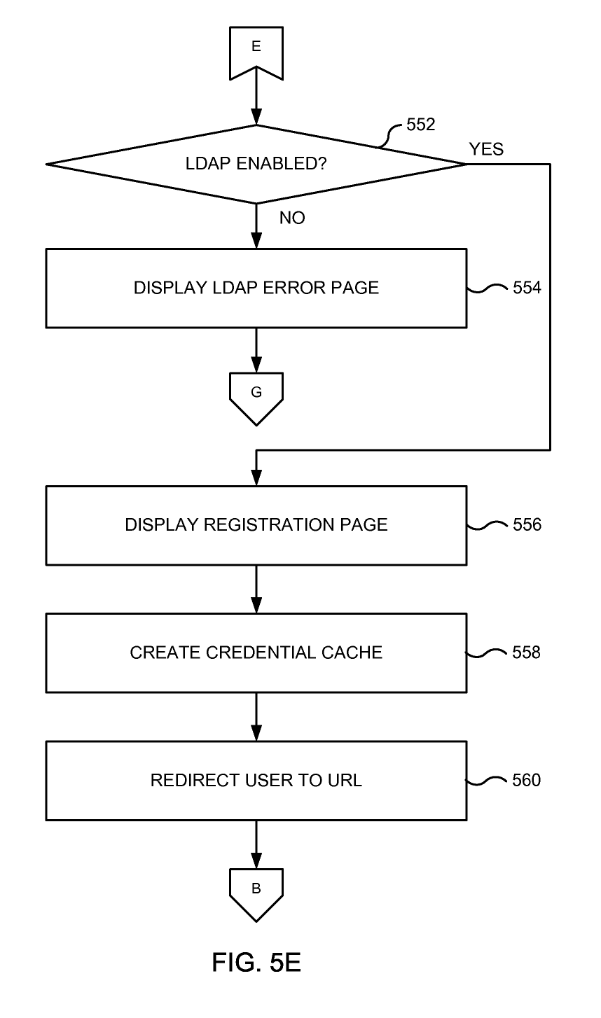

FIGS. 5A, 5B, 5C, 5D, and 5E are a flowchart of method 500 for authenticating HTTP URL traffic in one embodiment according to the present invention. Method 500 relates generally to authenticating or not authenticating passby HTTP traffic Some examples of settings that affect authentication of HTTP URL traffic may include:

1. Web Filtering Discovery or Impose Policy Mode

2. No Authentication

3. Transparent NTLM Authentication

4. Redirect Authentication

5. Block All Internet Access Until User Is Authenticated

FIG. 5A begins in step 502.

In step 504, a request to access an HTTP URL is received. For example, a web browser may issue a GET or POST command associated with an HTTP URL. In step 506, and IP address associated with the request is determined. For example, information about a source IP address or destination IP address may be obtained from an HTTP packet.

In step 508, a determination is made whether a non-expired entry exists in a credential cache. For example, network traffic monitor 120 may determine whether a mapping between the source IP address of HTTP network traffic and user credentials exists in an internal database. In step 508, if a determination is made that a non-expired entry does not exist in the credential cache, the processing of method 500 continues in step 520 of FIG. 5B.

Alternatively, in step 508, if a determination is made that a non-expired entry does exist in the credential cache, in step 510, a determination is made whether the IP address is associated with an unknown user. For example, the user credentials in the credential cache may be anonymous or may not have been authenticated to an LDAP or NTLM server. In step 510, if a determination is made that the IP addresses is not associated with an unknown user, in step 514, an appropriate policy to allow the user to access the HTTP URL.

Alternatively, in step 510, if a determination is made that the IP address is associated with an unknown user, in step 512, a determination is made whether to disallow an unidentified website (or unidentified HTTP network traffic). In step 512, if a determination is made to disallow an unidentified website, the processing of method 500 continues in step 520 of FIG. 5B. Alternatively, in step 512, if a determination is made to not disallow an unidentified website, in step 514, an appropriate policy to allow the user to access the HTTP URL is applied. FIG. 5A ends in step 518.

Referring to FIG. 5B, in step 520, a determination is made as to what type of authentication mode to use. In one embodiment, in step 520, a determination may be made to use no authentication. If a determination is made to use no authentication in step 520, the processing of method 500 continues in step 514 a FIG. 5A where an appropriate policy to allow the user to access the HTTP URL. For example, network traffic monitor 120 may not attempt to authenticate unknown users associated with HTTP GET request network traffic by challenging the network traffic. All such traffic may be classified as anonymous user, and the traffic can be subject to any blocking or filtering policy for unmapped users or groups.

In another embodiment, in step 520, a determination may be made to use a redirect to perform authentication. For example, network traffic monitor 120 may attempt to authenticate HTTP URL traffic by redirecting users who initiate HTTP network traffic to an authentication page which prompts for user credential information. If a determination is made to use a redirect to perform authentication in step 520, the processing of method 500 continues in step 534 of FIG. 5C.

In yet another embodiment, in step 520, a determination may be made to perform NTLM authentication. For example, network traffic monitor 120 may attempt to authenticate HTTP network traffic using NTLM authentication against a domain controller. The NTLM authentication may be performed transparently or non-transparently to the user. For example, in step 520, if a determination is made to perform NTLM authentication, in step 522, an NTLM prompt is displayed. The NTLM prompt may allow a user to enter a username and password. In some embodiments, the NTLM prompt may not be displayed, but a transparent NTLM authentication process may occur.

In step 524, a determination is made whether authentication is successful using the NTLM process. In step 526, if authentication is not successful or has failed, the processing of method 500 continues in step 540 of FIG. 5D. Alternatively, in step 526, if authentication is successful, a determination is made whether a user is found in an internal user database in step 528. In step 528, if a determination is made that a user is not found in the user database, the processing of method 500 continues in step 552 of FIG. 5D. In step 528, if a determination is made that the user is found in the use database, in step 530, a credential cache is created for the user. For example an entry may be placed in a credential cache mapping the authenticated user credentials to the determine the IP address. In step 532, the user may be redirect to the HTTP URL. The processing of method 500 and continues in step 514 of FIG. 5A, where an appropriate policy to allow the user to access the HTTP URL may be applied.

In various embodiments, NTLM, if configured properly, will trigger a web browser, such as Internet Explorer or Firefox, to automatically provide a user's credentials when the browser connects to the authentication page. In this case, one or more or all of the interactions described above can be completely transparent to users. From the user perspective, the user thinks he or she has just visited a web site without any interruption. In reality, authentication can take place behind the scene. If NTLM is not configured properly or the browser (e.g. Safari) does not support NTLM, a username-password challenge box may be displayed to prompt for user credentials.

In some embodiments, transparent NTLM authentication may be provided by forcing a client browser to automatically provide user credential. This behavior can be browser specific, and may be driven by end-user browser settings. In one example, by default browser settings, Internet Explorer may typically provide user credential automatically when users visit sites classified as “Local Intranet.” This configuration can be confirmed in the User Authentication section under IE-Tools-Internet Options-Security-Custom Level-Local Intranet. For Local Intranet, the setting should show “Automatically logon only in Local Intranet” is selected.

An authentication process may start when the end-user browser gets redirected to a page hosted on network traffic manager 120, for example. If network traffic manager 120 falls under Local Intranet or Trusted sites or both, the end-user browser can automatically send network traffic monitor the user's credentials.

In some embodiments, by default, Internet Explorer may treat any non-qualified hostname as Local Intranet. For example, hostnames like “corp-ntm” and “ntm” may be perceived as non-qualified while hostnames like “corp-ntm.example.com” and “ntm.example.com” are qualified. If the hostname of network traffic monitor 120 had been configured as “corp-ntm,” Internet Explorer may treat network traffic monitor 120 as Local Intranet when network traffic monitor 120 redirects Internet Explorer to “http://corp-ntm/ntlm.” Internet Explorer may automatically send the user credential to network traffic monitor 120. In various embodiments, this may be accomplished by using DNS configurations. Advantageously, no configuration changes may be needed on the end-user browser.

In further embodiments, an alternative approach may be to explicitly add qualified hostname to Internet Explorer's Local Intranet Sites by clicking on IE-Tools-Internet Options-Security-Local Intranet-Sites-Advanced and entering the qualified hostname of network traffic manager 120. A group policy can be used to facilitate to process of adding the hostname of network traffic manager 120 to all end-users' browsers.

Like Internet Explorer, Firefox may not automatically send user's NTLM credential to network traffic manager 120 by default. However, Firefox may be configured to do so.

Referring now to FIG. 5C, redirect authentication redirects a user to a web page hosted on network traffic manager 120 or the like. For example, in step 534, an authentication page is displayed. In step 536, a determination is made whether the user is authenticated. In step 536, if a determination is made that authentication is successful, the processing of method 500 continues in step 528 of FIG. 5D.

In one embodiment, prompts for username, password, and domain name may be made on an authentication page provided by network traffic manager 120. Once information is entered and submitted, network traffic manager 120 may contact an authentication source, such as a domain controller, to authenticate the user. In another embodiment, a specified external page can be used that performs the authentication on behalf of network traffic manager 120 and posts a set of predefined outcome parameters back to network traffic manager 120.

Alternatively, in step 536, if a determination is made that authentication has failed or is otherwise unsuccessful, in step 538, a determination is made whether the number of attempts to authenticate the user is greater than a given threshold or limit. But given threshold or limit may be set by a system administrator, such as limiting the number of login attempts to less than or equal to three. In step 540, if a determination is made that the number of login attempts is not greater than the threshold, the processing continues in step 534 where the authentication page is displayed. In step 540, if a determination is made that the number of log attempts is greater than the threshold, the processing of method 500 continues in step 546 of the FIG. 5D.

Referring now to FIG. 5D, if authentication fails due to incorrect username or password, in step 540, browser specific behavior may be implemented. For example, the browser may reinitiate authentication procedures. In step 542, and error message may be displayed. In step 546, the IP address is associated with an unknown user. In step 548, the credential cache is updated. A credential cache entry may be created or updated for the IP address which will be resolved to an unknown user. In step 550, the user is redirected to the original HTTP URL. When the user is redirected to the intended URL, this traffic may be classified as unmapped HTTP traffic, and can be subject to an unmapped HTTP filtering policy. The processing of method 500 then continues in step 514 of FIG. 5A.

Referring to FIG. 5E, if authentication was successful in step 526 of FIG. 5B, but in step 528, the user was not found in the user database, a determination may be made whether LDAP is enabled in step 552. It will be understood that a determination may be made whether other types of authentication mechanisms are available in the place of NTLM and LDAP.

In step 552, if a determination is made that LDAP is not enabled, in step 554, an LDAP error message may be displayed. The processing of method 500 then continues in step 546 of FIG. 5D. In step 552, if a determination is made that LDAP is enabled, in step 556, a registration page may be displayed. For example, a user may be redirected to employee registration page where the user's employee ID may be shown. The user may be prompted for last/first name and email address. On submitting this information from the registration page, a credential cache is created in step 558. For example, an entry for the registered user may be created in the credential cache mapping the IP address to the user's credentials. In step 560, the user is redirected to the original HTTP URL. The processing of method 500 then continues in step 514 of FIG. 5A.

In some embodiments, redirecting the user to the intended page may not be done since registration can be a one time only process. The user may be expected to re-enter the intended URL to visit the URL.

Accordingly, authentication of network traffic may occur based on whether one or more policies apply for an identified user or group who initiates the network traffic. As discussed above, by proxying network traffic, such as IM communications, a proxy server can know which users are associated with what network traffic. In another example, transparent and non-transparent mechanisms may be provided to authenticate HTTP URL traffic. As discussed further below, other types of traffic, such as non-proxied IM, P2P, and spyware, an existing authentication cache or credential cache may be used to identify the user who generated the traffic.

In various embodiments, network traffic manager 120 may attempt to enforce that other types of network traffic, such as IM clients that bypass a proxy server, P2P applications and other unauthorized user-installed applications, spyware, malware, or the like, be authenticated. Network traffic manager 120 may employ a credential cache to resolve IP address to users and user credentials for these types of network traffic that may not readily be authenticated using a proxy mechanism or NTLM mechanism as discussed above.

A credential cache can include any storage elements for storing transient IP-to-user mapping information. In one example, a credential cache entry may include a timestamp, which can allow network traffic monitor 120 to invalidate an entry after a configured timeout value or period. A credential cache may be shared between different traffic analysis modules (e.g., modules 240, 245, 250, 255 of FIG. 2) so that a valid entry created by one module can be accessed and reused by another module. For example, if AOL module 240 creates an entry, HTTP module 250 can access the entry to forgo another authentication for the user access.

In addition to modules of network manager 120 which may create or update entries in a credential cache, there can be other multiple ways to create or update an entry in the credential cache. In one embodiment, an agent can be used to obtain a list of devices or hosts that are active on a computer network. The agent then may query each of the devices or hosts on the computer network to obtain information about any users who may be using the devices or hosts. The agent then may update a credential cache with the list of users and the IP address of the devices or hosts on the computer network.

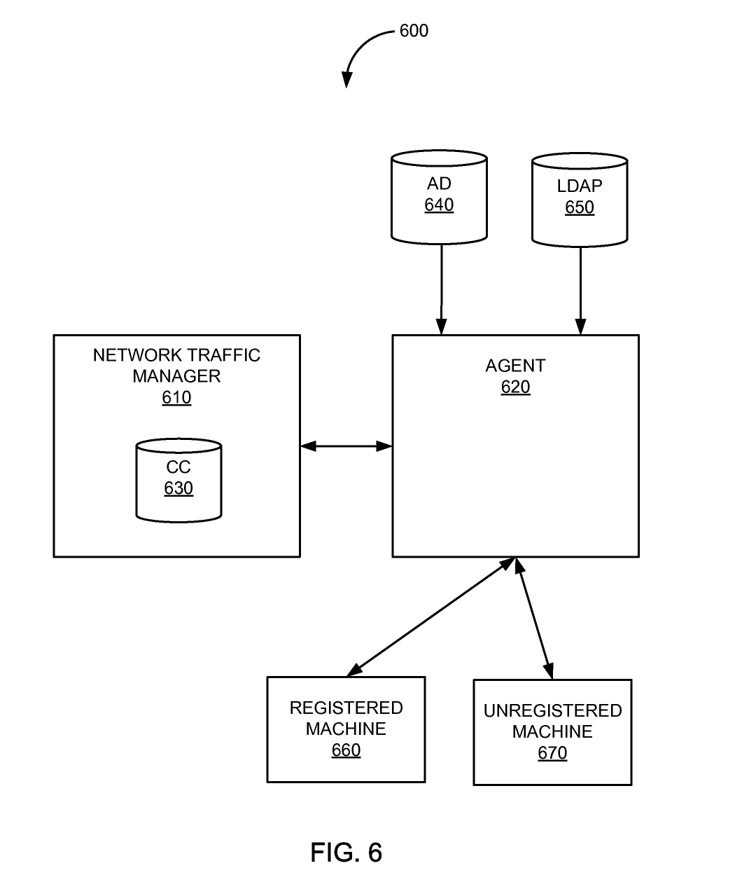

FIG. 6 is a block diagram of system 600 for agent-based management of network traffic in one embodiment according to the present invention. In this example, system 600 includes network traffic monitor 610 and agent 620. Network traffic monitor 610 may be embodied as network traffic monitor 120 in FIG. 1. In this example, network traffic monitor 610 can include credential cache 630. Network traffic monitor 610 may use credentials cache 630 to identify users who initiate network traffic to authenticate the network traffic as discussed above.

In this example, agent 620 may include hardware and/or software elements for querying computers and devices for user information. Agent 620 may obtain information about computers or other devices from Active Directory 640 or from LDAP 650. For example, a system administrator may register each computer or device that accesses an organizations network in Active Directory 640 or LDAP 650. Agent 620 may query these database to obtain information about which machines or device may be present on the organizations network.

Agent 620 then may query each of the machines or devices whose information was obtained from Active Directory 640 or LDAP 650 to determine information about users who may be using those machines. For example, agent 620 may query registered machine 660 for the user name of any users who may be using the machine. Agent 620 may match the username to a user's credentials, and create a user-to-IP address mapping in credential cache 630.

In some embodiments, agent 620 may periodically scan the organizations network for unregistered or rouge machines. In one example, network traffic manager 610 may detect network traffic originating from an IP address that does not have a user-to-IP address mapping in credential cache 630. Network traffic manager may send the IP address to agent 620, which can scan the machine or device associated with the IP address to determine any available user information. Agent 620 may then update credential cache 630 based on the results of the scan. For example, agent 620 may find a match between the user of unregistered machine 670 and a user Active Directory 640 or LDAP 650. In another example, agent 620 may determine the user of unregistered machine 670 to be an unknown user, and update credential cache 630 with such a mapping.

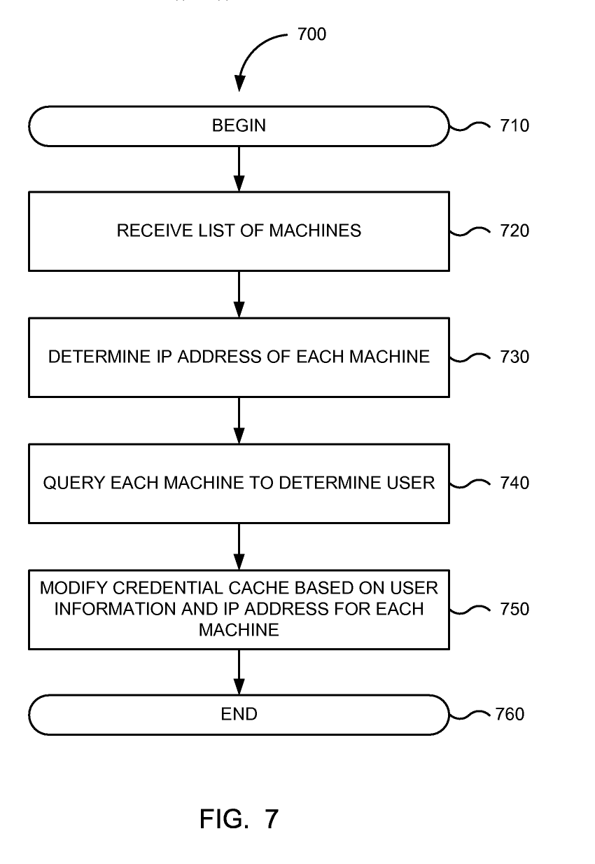

FIG. 7 is a flowchart of method 700 for querying machines to obtain user information for agent-based network traffic management in one embodiment according to the present invention. FIG. 7 begins in step 710.

In step 720, a list of machines is received. The list of machines may be determined from a registry of machines, a file of machine names, a network scan, or the like. In step 730, an IP address of each machine in the list is determined. Various mechanisms may be used to determine the IP address of a machine. For example, the IP address may be included in the registry of machines or the file of machine names. In another example, a name-to-address resolution system may be used, such as DNS or WINS. In yet another example, a series of IP addresses may be scanned to determine whether a machine responds on a particular IP address.

In step 740, each machine is queried to determine a users associated with the machine. For example, a process executing on each machine may be queried to determine which users are logged on to a given machine. In step 750, the credential cache is modified based on the user information and IP address obtained for each machine. FIG. 7 ends in step 760.

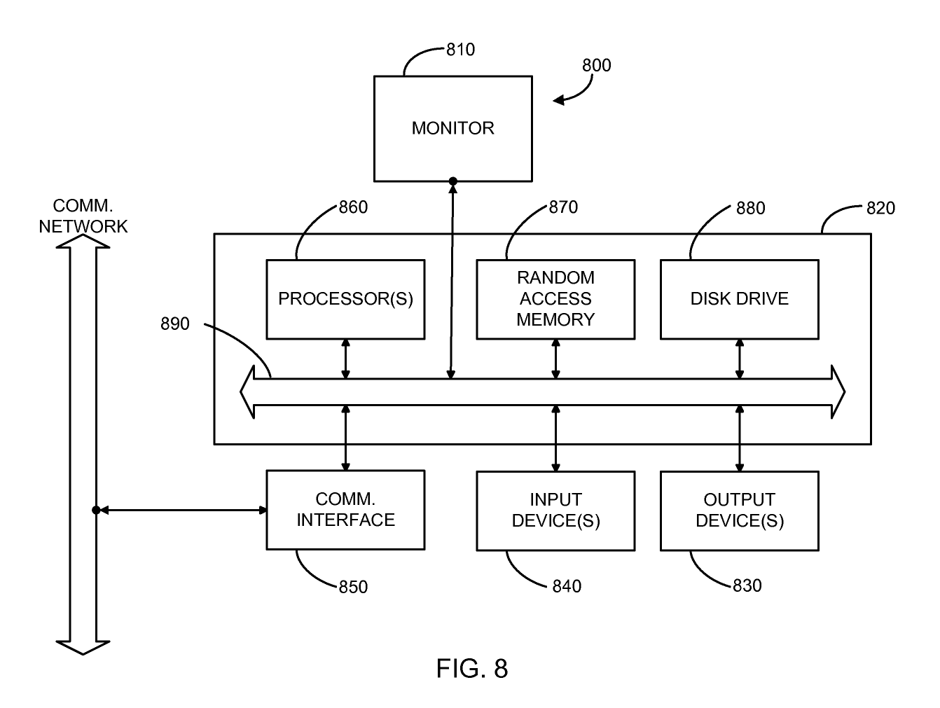

FIG. 8 is a simplified block diagram of computer system 800 that may incorporate embodiments of the present invention. FIG. 8 is merely illustrative of an embodiment incorporating the present invention and does not limit the scope of the invention as recited in the claims. One of ordinary skill in the art would recognize other variations, modifications, and alternatives.

In one embodiment, computer system 800 typically includes a monitor 810, a computer 820, user output devices 830, user input devices 840, communications interface 850, and the like.

As shown in FIG. 8, computer 820 may include a processor(s) 860 that communicates with a number of peripheral devices via a bus subsystem 890. These peripheral devices may include user output devices 830, user input devices 840, communications interface 850, and a storage subsystem, such as random access memory (RAM) 870 and disk drive 880.

User input devices 830 include all possible types of devices and mechanisms for inputting information to computer system 820. These may include a keyboard, a keypad, a touch screen incorporated into the display, audio input devices such as voice recognition systems, microphones, and other types of input devices. In various embodiments, user input devices 830 are typically embodied as a computer mouse, a trackball, a track pad, a joystick, wireless remote, drawing tablet, voice command system, eye tracking system, and the like. User input devices 830 typically allow a user to select objects, icons, text and the like that appear on the monitor 810 via a command such as a click of a button or the like.

User output devices 840 include all possible types of devices and mechanisms for outputting information from computer 820. These may include a display (e.g., monitor 810), non-visual displays such as audio output devices, etc.

Communications interface 850 provides an interface to other communication networks and devices. Communications interface 850 may serve as an interface for receiving data from and transmitting data to other systems. Embodiments of communications interface 850 typically include an Ethernet card, a modem (telephone, satellite, cable, ISDN), (asynchronous) digital subscriber line (DSL) unit, FireWire interface, USB interface, and the like. For example, communications interface 850 may be coupled to a computer network, to a FireWire bus, or the like. In other embodiments, communications interfaces 850 may be physically integrated on the motherboard of computer 820, and may be a software program, such as soft DSL, or the like.

In various embodiments, computer system 800 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 820 includes one or more Xeon microprocessors from Intel as processor(s) 860. Further, one embodiment, computer 820 includes a UNIX-based operating system.

RAM 870 and disk drive 880 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 870 and disk drive 880 may be configured to store the basic programming and data constructs that provide the functionality of the present invention.

Software code modules and instructions that provide the functionality of the present invention may be stored in RAM 870 and disk drive 880. These software modules may be executed by processor(s) 860. RAM 870 and disk drive 880 may also provide a repository for storing data used in accordance with the present invention.

RAM 870 and disk drive 880 may include a number of memories including a main random access memory (RAM) for storage of instructions and data during program execution and a read only memory (ROM) in which fixed instructions are stored. RAM 870 and disk drive 880 may include a file storage subsystem providing persistent (non-volatile) storage for program and data files. RAM 870 and disk drive 880 may also include removable storage systems, such as removable flash memory.

Bus subsystem 890 provides a mechanism for letting the various components and subsystems of computer 820 communicate with each other as intended. Although bus subsystem 890 is shown schematically as a single bus, alternative embodiments of the bus subsystem may utilize multiple busses.

FIG. 8 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method performed by a network appliance for identifying users associated with network traffic, the method comprising:
receiving a first type of network traffic;
determining a source network address of the first type of network traffic;
determining information associating a user with a source network address of a second type of network traffic; and
performing an action with the first type of network traffic based on the source network address of the first type of network traffic and the information associating the user with the source network address of the second type of network traffic.

2. The method of claim 1 wherein determining information associating a user with a second type of network traffic comprises determining a mapping between the user and the source network address of the second type of network traffic.

3. The method of claim 1 wherein determining information associating a user with a second type of network traffic comprises obtaining information associating user credentials of the user with the source network address of the second type of network traffic

4. The method of claim 1 wherein performing the action with the first type of network traffic comprises:
determining a match between the source network address of the first type of network traffic and the source address of the second type of network traffic.

5. The method of claim 1 wherein performing the action with the first type of network traffic comprises logging the first type of network traffic as being associated with the user.

6. The method of claim 1 wherein performing the action with the first type of network traffic comprises blocking the first type of network traffic.

7. The method of claim 1 further comprising:
receiving the second type of network traffic;
determining the source network address of the second type of network traffic;
identifying the user as being associated with a network host having the source address of the second type of network traffic; and
generating and storing the information associating the user with the source network address of the second type of network traffic.

8. The method of claim 1 further comprising:
receiving the second type of network traffic comprising HTTP traffic;
requesting user credentials from a browser that originated the HTTP traffic;
generating a request to validate the user credentials;
receiving a response validating the user credentials; and
generating the information associating the user with the source network address of the second type of network traffic based on the response validating the user credentials.

9. The method of claim 8 further comprising:
transparently receiving the user credentials from the browser using NTLM.

10. The method of claim 8 wherein requesting user credentials from the browser comprises redirecting the browser to a web page that enables the user to enter a username and password.

11. The method of claim 1 further comprising:
receiving the second type of network traffic comprising IM traffic indicative of a request from an IM client associated with the user to access an IM network;
receiving an indication that the user is allowed to access the IM network; and
generating the information associating the user with the source network address of the second type of network traffic based on the indication that the user is allowed to access the IM network.

12. A computer-readable storage medium configured to store program code of a network appliance for identifying users associated with network traffic, the computer-readable storage medium comprising:
code for receiving a first type of network traffic;
code for determining a source network address of the first type of network traffic;
code for determining information associating a user with a source network address of a second type of network traffic; and
code for performing an action with the first type of network traffic based on the source network address of the first type of network traffic and the information associating the user with the source network address of the second type of network traffic.

13. The computer-readable storage medium of claim 12 wherein the code for determining information associating a user with a second type of network traffic comprises code for determining a mapping between the user and the source network address of the second type of network traffic.

14. The computer-readable storage medium of claim 12 wherein the code for determining information associating a user with a second type of network traffic comprises code for obtaining information associating user credentials of the user with the source network address of the second type of network traffic

15. The computer-readable storage medium of claim 12 wherein the code for performing the action with the first type of network traffic comprises:
code for determining a match between the source network address of the first type of network traffic and the source address of the second type of network traffic.

16. The computer-readable storage medium of claim 12 wherein the code for performing the action with the first type of network traffic comprises code for logging the first type of network traffic as being associated with the user.

17. The computer-readable storage medium of claim 12 wherein the code for performing the action with the first type of network traffic comprises code for blocking the first type of network traffic.

18. The computer-readable storage medium of claim 12 further comprising:
code for receiving the second type of network traffic;
code for determining the source network address of the second type of network traffic;
code for identifying the user as being associated with a network host having the source address of the second type of network traffic; and
code for generating and storing the information associating the user with the source network address of the second type of network traffic.

19. The computer-readable storage medium of claim 12 further comprising:
code for receiving the second type of network traffic comprising HTTP traffic;
code for requesting user credentials from a browser that originated the HTTP traffic;
code for generating a request to validate the user credentials;
code for receiving a response validating the user credentials; and
code for generating the information associating the user with the source network address of the second type of network traffic based on the response validating the user credentials.

20. The computer-readable storage medium of claim 19 further comprising:
code for transparently receiving the user credentials from the browser using NTLM.

21. The computer-readable storage medium of claim 19 wherein the code for requesting user credentials from the browser comprises code for redirecting the browser to a web page that enables the user to enter a username and password.

22. The computer-readable storage medium of claim 12 further comprising:
code for receiving the second type of network traffic comprising IM traffic indicative of a request from an IM client associated with the user to access an IM network;
code for receiving an indication that the user is allowed to access the IM network; and
code for generating the information associating the user with the source network address of the second type of network traffic based on the indication that the user is allowed to access the IM network.

23. A network appliance for identifying users associated with network traffic, the network appliance comprising:
a communications interface configured to exchange data with a communications network; and
a processor configured to:
determine a source network address of a first type of network traffic;
determine information associating a user with a source network address of a second type of network traffic; and
perform an action with the first type of network traffic based on the source network address of the first type of network traffic and the information associating the user with the source network address of the second type of network traffic.

24. The network appliance of claim 23 wherein the processor is further configured to:
receive the second type of network traffic comprising HTTP traffic;
request user credentials from a browser that originated the HTTP traffic;
generate a request to validate the user credentials;
receive a response validating the user credentials; and
generate the information associating the user with the source network address of the second type of network traffic based on the response validating the user credentials.

25. The network appliance of claim 24 wherein the processor is further configured to:
transparently receive the user credentials from the browser using NTLM.

26. The network appliance of claim 24 wherein the processor is further configured to:
redirecting the browser to a web page that enables the user to enter a username and password.

27. The network appliance of claim 23 wherein the processor is further configured to:
receive the second type of network traffic comprising IM traffic indicative of a request from an IM client associated with the user to access an IM network;
receive an indication that the user is allowed to access the IM network; and
generate the information associating the user with the source network address of the second type of network traffic based on the indication that the user is allowed to access the IM network.
